(19) United States
(12) Patent Application Publication
(10) Pub. No.: US 2014/0145965 A1
(43) Pub. Date: May 29, 2014

(54) TOUCH DEVICE AND DRIVING METHOD OF TOUCH PANEL THEREOF

(71) Applicant: HIMAX TECHNOLOGIES LIMITED, Tainan City (TW)

(72) Inventors: Jui-Ming Liu, Tainan City (TW); Li-Lin Liu, Tainan City (TW); Chung-Wen Chang, Tainan City (TW); Shen-Feng Tai, Tainan City (TW)

(73) Assignee: HIMAX TECHNOLOGIES LIMITED, Tainan City (TW)

(21) Appl. No.: 13/686,046

(22) Filed: Nov. 27, 2012

(51) Int. Cl. G06F 3/041

(52) U.S. Cl. CPC G06F 3/0416
USPC 345/173; 178/18.03

(57) ABSTRACT

A touch device and a driving method of the touch panel thereof are provided. By randomly driving the scan lines and performing a spatial filtering to the count values corresponding to the voltage noise, a circumstance of a touch position misjudgement caused by voltage noise may be improved.

### BACKGROUND OF THE INVENTION

1. Field of the Invention

The invention relates to a touch device and a driving method of a touch panel thereof. More specifically, the invention relates to a touch device and a driving method of a touch panel thereof for improving a circumstance of a touch position misjudgement caused by a voltage noise.

2. Description of Related Art

With the rapid development of technology, most electronic devices, such as notebook computers, mobile phones or portable multimedia players, usually have touch panels serving as input interfaces of a new generation. Based on different sensing types, a touch-sensing panel can be generally categorized into a resistance touch-sensing panel, a capacitive touch-sensing panel, an optical touch-sensing panel, an acoustic-wave touch-sensing panel and an electromagnetic touch-sensing panel. The capacitive touch sensing panel is characterized by short response speed, favorable reliability, satisfactory durability, and so on. Therefore, the capacitive touch-sensing panel is widely used in the electronic products.

The capacitive touch panels are operated by approaching or touching the touch panels with a finger or a conductive material to change capacitances of the touch panel. When a capacitance variation is detected, a position approached or touched by the finger or the conductive material is determined.

In recent day, as limited by the restriction of the battery capacity, it is quite often that the electronic products such as the cell phone and tablet computer may be used while charging. However, when an electronic product is connected to a charger, a noise may be generated by the charger during a process of converting AC voltage to DC voltage. The noise may affect a detected result of the capacitances through a ground terminal of a chip circuit in the electronic product, causing circumstance that reduces the quality in use, such as misjudgement to the touched point or reduction of the touch sensitiveness.

FIG. 1 is a touching schematic view of a conventional capacitive touch panel. As shown in FIG. 1, the touch-sensing method of the conventional capacitive touch panel is as follows. Sequentially driving a plurality of scan lines (referring to FIG. 1, sequentially driving the scan lines TX1 to TX5); receiving a plurality of touch-sensing signals through a plurality of sense lines during a driving period of each scan line (referring to FIG. 1, receiving the sensing signals through the sense lines RX1˜RX8); and determining a touch position based on the capacitance variation on the conventional capacitive touch panel which is obtained from the touch-sensing signals. Referring to FIG. 1, when the positions of the scan lines TX4, TX5 and the sense lines RX3-RX5 are touched by a user, the capacitance variations corresponding to said positions are different from the rest of the positions so that the actual positions touched by the user may be obtained thereby.

Although the touch-sensing method of the conventional capacitive touch panel may effectively determine the touch position of the user, the problem of the touch position misjudgement caused by the noises generated by the charger is still unavoidable. As shown in FIG. 1, it is assumed that a AC voltage noise caused by an adapter is generated in the areas between the scan lines TX1 to TX3 to affect the capacitances of the panel capacitance, such that a sensor used for detecting capacitance variations may misjudge that the conventional capacitive touch panel has been touched. As shown in FIG. 1, in the case where the AC voltage noise is generated on the scan lines RX3 to RX5, the sensor determines that the positions on the cross points of the scan lines TX1 to TX3 and the sense lines RX3 to RX5 have been touched.

### SUMMARY OF THE INVENTION

The invention is directed to a touch device and a driving method of a touch panel thereof, for improving a circumstance of a touch position misjudgement caused by a voltage noise.

The invention provides a driving method of a touch panel, in which the touch panel includes a plurality of scan lines and a plurality of sense lines, the driving method includes the following steps: randomly driving the plurality of scan lines during a sensing period, wherein each of the plurality of scan lines is respectively driven once during the sensing period; receiving a plurality of touch-sensing signals from the plurality of sense lines; and determining a touch position of the touch panel according to the plurality of touch-sensing signals.

According to an embodiment of the invention, in which the step of determining the touch position of the touch panel according to the plurality of touch-sensing signals further includes the following steps: generating a plurality of count values according to the plurality of the touch-sensing signals; performing a spatial filtering to the plurality of count values; and determining the touch position of the touch panel according to a result of the spatial filtering.

The invention further provides a touch device, including a touch panel, a driving module, a sensing unit and a processing unit. In which the touch panel includes a plurality of scan lines and a plurality of sense lines; The driving module is coupled to the plurality of scan lines, configured for randomly driving the plurality of scan lines during a sensing period, in which each of the plurality of scan lines is respectively driven once during the sensing period. The sensing unit is coupled to the plurality of sense lines, configured for receiving a plurality of touch-sensing signals form the plurality of sense lines and generating a plurality of count values according to the plurality of the touch-sensing signals. The processing unit is coupled to the driving module and the sensing unit, configured for determining a touch position of the touch panel according to the plurality of count values.

According to an embodiment of the invention, in which the processing unit further performs a spatial filtering to the plurality of count values, and determines the touch position of the touch panel according to a result of the spatial filtering.

According to an embodiment of the invention, the driving module includes a random number generator and a driving unit. In which, the random number generator is configured for generating a random number value. The driving unit is coupled to the random number generator, the plurality of scan lines and the processing unit, configured for randomly driving the plurality of scan lines according to the random number value.

According to an embodiment of the invention, the sensing unit includes an integrator, an analog-to-digital converter and a counter. In which the integrator is coupled to the plurality of sense lines, configured for performing an integration respectively to the plurality of touch-sensing signals to obtain a plurality of touch-sensing voltages. The analog-to-digital converter is coupled to the integrator, configured for converting the plurality of touch-sensing voltages to a plurality of digital signals; and the counter is coupled to the analog-to-digital converter and the processing unit, configured for generating the plurality of count values according to the digital signals.

Based on above, by randomly driving the touch panel, the invention may improve a circumstance of a touch position misjudgement caused by a voltage noise.

To make the above features and advantages of the invention more comprehensible, several embodiments accompanied with drawings are described in detail as follows.

### BRIEF DESCRIPTION OF THE DRAWINGS

FIG. 1 is a touching schematic view of a conventional capacitive touch panel.

FIG. 2 is a schematic view of a touch device according to an embodiment of the invention.

FIG. 3 is a touching schematic view of a touch panel according to an embodiment of the invention.

FIG. 4A is a schematic view of count values obtained by using a driving method for scan lines of a touch panel in conventional art.

FIG. 4B is a schematic view of count values obtained by using a driving method for scan lines of a touch panel according to an embodiment of the invention.

FIG. 5 is a schematic flowchart of a driving method of a touch panel according to an embodiment of the invention.

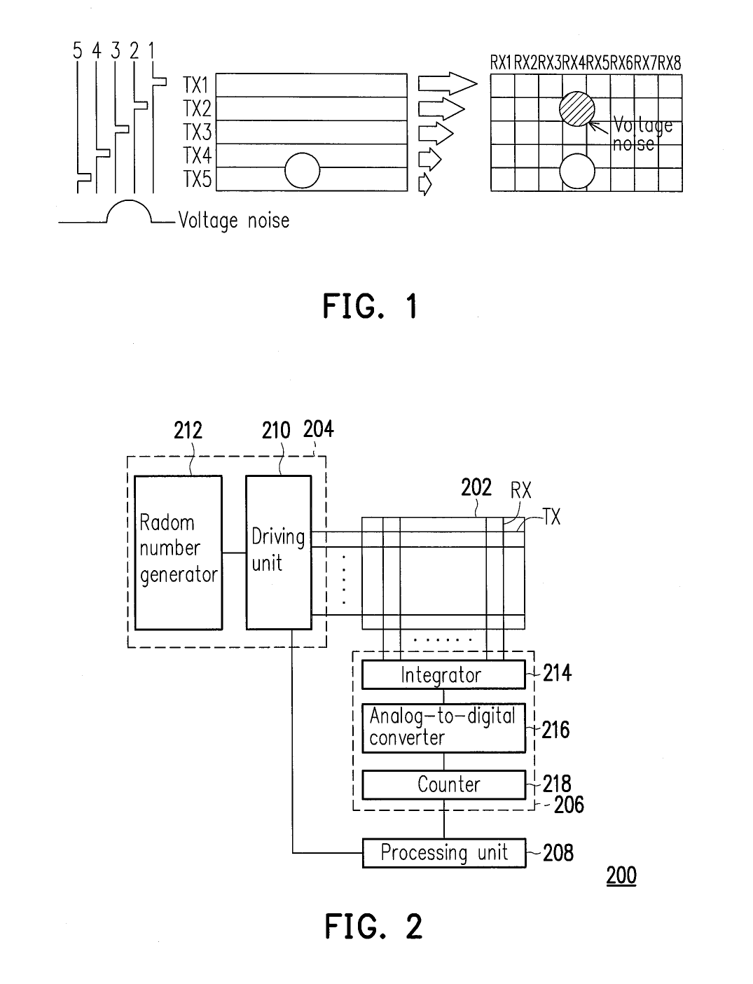

### DESCRIPTION OF THE EMBODIMENTS

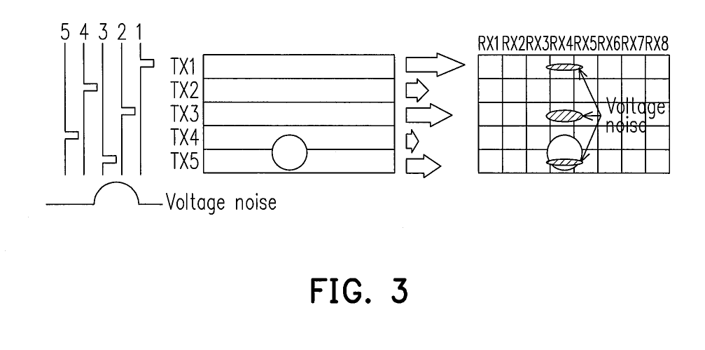

FIG. 2 is a schematic view of a touch device according to an embodiment of the invention. Referring to FIG. 2, a touch device 200 includes a touch panel 202, a driving module 204, a sensing module 206 and a processing unit 208. The touch panel 202 includes a plurality of scan lines TX and a plurality of sense lines RX, in which the plurality of scan lines TX are coupled to the driving module 204, and the plurality of sense lines RX are coupled to the sensing unit 206. In addition, the driving module 204 and the sensing unit 206 are coupled to the processing unit 208.

When a touch-detecting is performed by the touch device 200, the driving module 204 drives the plurality of scan lines TX on the touch panel 202 respectively during different sensing periods, in which each of the scan lines TX is driven once during each sensing period. The scan lines TX are randomly driven by the driving module 204 during each period.

Further, the driving module 204 may include a driving unit 210 and a random number generator 212, in which the random number generator 212 is coupled to the driving unit 210, the driving unit 210 is coupled to the plurality of scan lines TX and the processing unit 208. The random number generator 212 generates a random number value, so that the driving unit 210 may randomly drive the plurality of scan lines TX according to the random number value and transmit an driving order of the scan lines TX to the processing unit 208.

The sensing unit 206 receives touch-sensing signals form the plurality of sense lines RX and generates a plurality of count values according to the received touch-sensing signals. Further, the sensing unit 206 may include an integrator 214, an analog-to-digital converter 216 and a counter 218. The integrator 214 is coupled to the sense lines RX, the analog-to-digital converter 216 is coupled to integrator 214, the counter 214 and the processing unit 218. The integrator 214 performs an integration respectively to the plurality of touch-sensing signals received from the scan lines RX to obtain a plurality of touch-sensing voltages. The analog-to-digital converter 216 converts the touch-sensing voltages to a plurality of digital signals. The counter 218 generates the plurality of count values according to the plurality of digital signals.

The processing unit 208 determines a touch position of the touch panel 202 according to the plurality of count values outputted by the sensing unit 206. For example, the processing unit 208 may perform a spatial filtering to the count values received to further reduce affection of a voltage noise, thereby determining an accurate touch position based on a result of the spatial filtering.

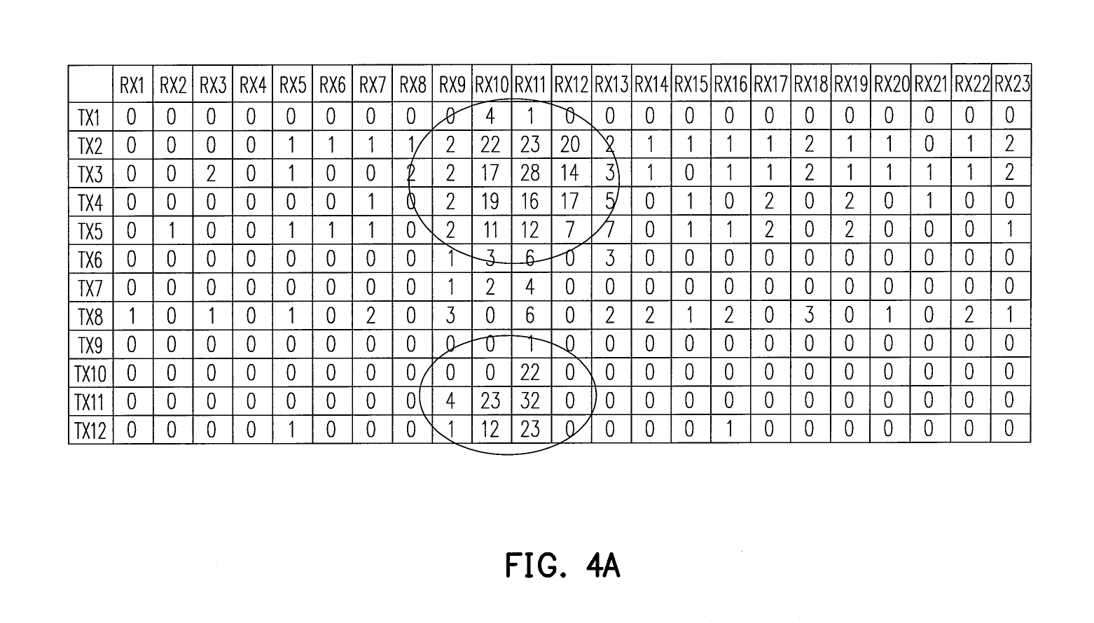

As a result of randomly driving the scan lines TX, the voltage noise may be distributed non-adjacent scan lines, thereby reducing the affection of the voltage noise. FIG. 3 is a touching schematic view of a touch panel according to an embodiment of the invention. Referring to FIG. 3, by randomly driving the scan lines TX, a range affected by the voltage noise may be effectively distributed. A driving order of the scan lines TX as shown in FIG. 3 is TX1, TX3, TX5, TX2 and TX4. Such driving order may distribute the voltage noise to the scan lines TX1, TX3 and TX5, thereby reducing the range affected by the voltage noise.

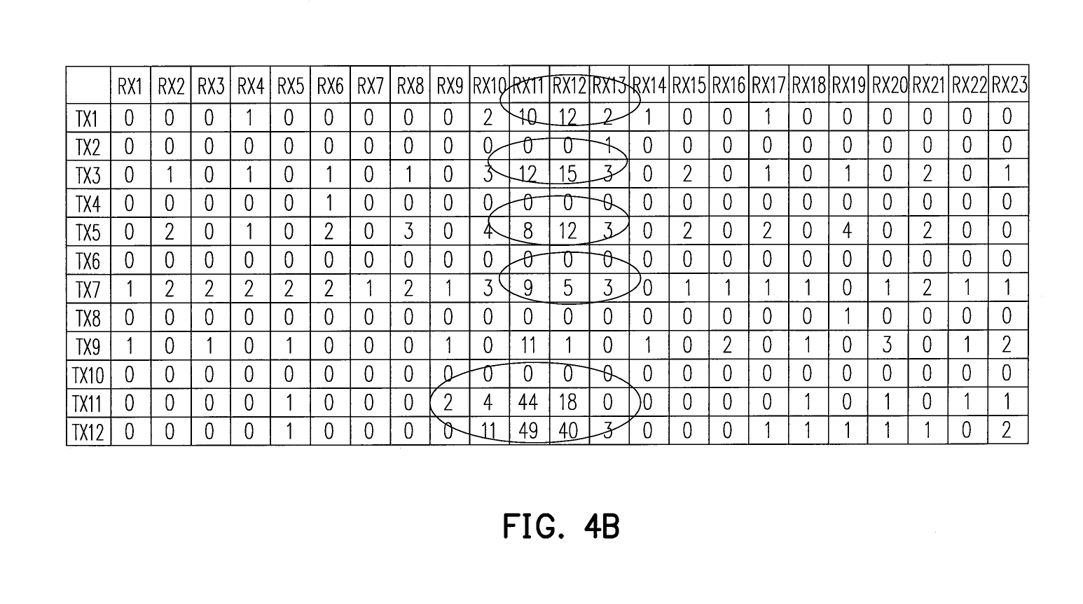

In addition, the count values corresponding to the voltage noise may also be reduced by randomly driving the scan lines TX. FIG. 4A is a schematic view of count values obtained by using a driving method for scan lines of a touch panel in conventional art. FIG. 4B is a schematic view of count values obtained by using a driving method for scan lines of a touch panel according to an embodiment of the invention.

As illustrated in FIG. 4A and FIG. 4B, after the touch-sensing is performed by randomly driving the scan lines TX, the count values corresponding to the voltage noise being distributed to different scan lines TX became smaller, namely, the signal strength of the voltage noise is weaken. After the spatial filtering is performed by the processing unit 208 to the count values that became smaller, the count values corresponding to the voltage noise may be filtered in order to avoid the touch position misjudgement.

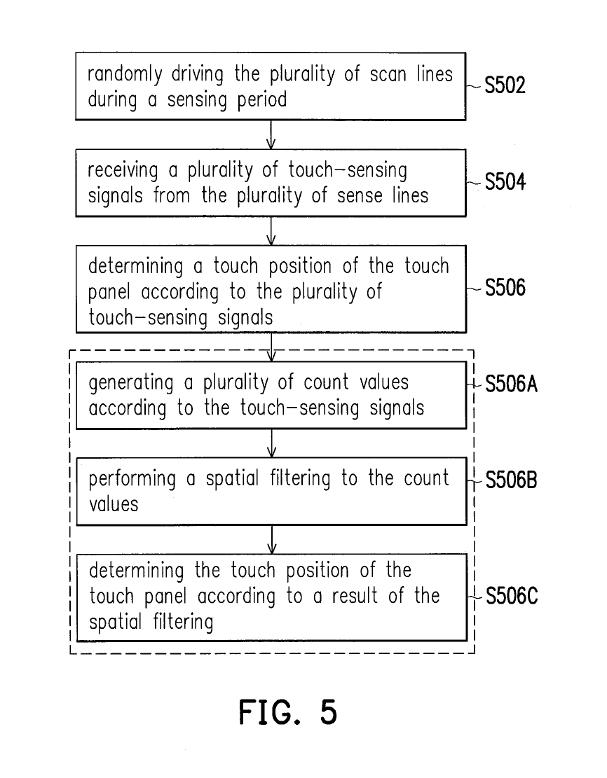

FIG. 5 is a schematic flowchart of a driving method of a touch panel according to an embodiment of the invention. Referring the driving method of the touch panel 202 in FIG. 5, the driving method of the touch panel may be summarized as follows. Firstly, randomly driving the plurality of scan lines during a sensing period (step S502), in which each of the plurality of scan lines is respectively driven once during the sensing period Next, receiving a plurality of touch-sensing signals from the plurality of sense lines (step S504). Lastly, determining a touch position of the touch panel according to the plurality of touch-sensing signals (step S506). More specifically, step S506 may further include the following steps. Generating a plurality of count values according to the touch-sensing signals (step S506A); performing a spatial filtering to the count values (step S506B); and determining the touch position of the touch panel according to a result of the spatial filtering (step S506C).

In view of above, by randomly driving the scan lines, the invention may distribute the voltage noise to the non-adjacent scan lines, thereby reducing the signal strength of the voltage noise. Further, by performing a spatial filtering to the count values corresponding to the voltage noise, the circumstance of the touch position misjudgement caused by voltage noise may be improved.

Although the invention has been described with reference to the above embodiments, it is apparent to one of the ordinary skill in the art that modifications to the described embodiments may be made without departing from the spirit of the invention. Accordingly, the scope of the invention will be defined by the attached claims not by the above detailed descriptions.

What is claimed:

1. A driving method of a touch panel, wherein the touch panel comprises a plurality of scan lines and a plurality of sense lines, the driving method comprising:
randomly driving the plurality of scan lines during a sensing period, wherein each of the plurality of scan lines is respectively driven once during the sensing period;
receiving a plurality of touch-sensing signals from the plurality of sense lines; and
determining a touch position of the touch panel according to the plurality of touch-sensing signals.

2. The driving method for the touch panel of claim 1, wherein the step of determining the touch position of the touch panel according to the plurality of touch-sensing signals further comprises:
generating a plurality of count values according to the plurality of the touch-sensing signals;
performing a spatial filtering to the plurality of count values; and
determining the touch position of the touch panel according to a result of the spatial filtering.

3. A touch device, comprising:
a touch panel, comprising a plurality of scan lines and a plurality of sense lines;
a driving module, coupled to the plurality of scan lines, configured for randomly driving the plurality of scan lines during a sensing period, wherein each of the plurality of scan lines is respectively driven once during the sensing period;
a sensing unit, coupled to the plurality of sense lines, configured for receiving a plurality of touch-sensing signals form the plurality of sense lines and generating a plurality of count values according to the plurality of the touch-sensing signals; and
a processing unit, coupled to the driving module and the sensing unit, configured for determining a touch position of the touch panel according to the plurality of count values.

4. The touch device of claim 3, wherein the processing unit further performs a spatial filtering to the plurality of count values, and determines the touch position of the touch panel according to a result of the spatial filtering.

5. The touch device of claim 3, wherein the driving module comprises:
a random number generator, configured for generating a random number value; and
a driving unit, coupled to the random number generator, the plurality of scan lines and the processing unit, configured for randomly driving the plurality of scan lines according to the random number value.

6. The touch device of claim 3, wherein the sensing unit comprises:
an integrator, coupled to the plurality of sense lines, configured for performing an integration respectively to the plurality of touch-sensing signals to obtain a plurality of touch-sensing voltages;
an analog-to-digital converter, coupled to the integrator, configured for converting the plurality of touch-sensing voltages to a plurality of digital signals; and
a counter, coupled to the analog-to-digital converter and the processing unit, configured for generating the plurality of count values according to the count values.
